(19) United States
(12) Patent Application Publication
(10) Pub. No.: US 2025/0335182 A1
(43) Pub. Date: Oct. 30, 2025

(54) DEPLOYMENT RISK MANAGEMENT USING DISTANCE MATRICES

(71) Applicant: Dell Products L.P., Round Rock, TX (US)

(72) Inventors: VINAY SAWAL, Fremont, CA (US); TSEHSIN JASON LIU, Wellesley, MA (US); CARL ASHBY, Derry, NH (US)

(21) Appl. No.: 18/646,158

(22) Filed: Apr. 25, 2024

(51) Int. Cl. G06F 8/71; G06F 8/60; G06F 8/77

(52) U.S. Cl. CPC G06F 8/71; G06F 8/60; G06F 8/77

(57) ABSTRACT

Methods and systems for managing deployments that provide computer-implemented services using one or more data processing systems are provided. A risk estimation process may be employed to identify and quantify difference(s) between two deployments (namely, an existing deployment and a new deployment) in a normalized and quantitative manner. Such difference(s) may be used to determine a level of risk associated with deploying the new deployment. This level of risk may then be compared against deployment policies of an entity to determine whether the new deployment may actually be deployed.

### FIELD

Embodiments disclosed herein relate generally to managing a configuration of a client deployment to provide a service. More particularly, embodiments disclosed herein relate to managing changes to a client deployment that may lower quality of the services provided by the client deployment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with one or more embodiments.

FIGS. 2A-2C show data flow diagrams in accordance with one or more embodiments.

FIGS. 2D-2H show implementation examples in accordance with one or more embodiments.

FIGS. 3A-3B show flow diagrams illustrating methods in accordance with one or more embodiments.

FIG. 4 shows a block diagram illustrating a data processing system in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a configuration of a client deployment (also referred to herein as just a “deployment”) to provide services (e.g., computer-implemented services). In particular, a continuous integration and continuous delivery/continuous deployment pipeline (CI/CD) may be used to provide agile, frequent, and reliable deployment (e.g., software deployment) delivery process. The iterative nature and methodologies of CI/CD pipelines allow development teams to collaboratively write code, integrate code, run tests, deliver releases, and deploy changes to existing deployments in real time.

In a distributed environment (e.g., a distributed Cloud Platform), change to deployments is a common occurrence, particularly when CI/CD pipelines are involved. It is not uncommon for a particular deployment (e.g., a software deployment) to experience multiple changes (e.g., updates, modifications, or the like) over the course of a single day. However, every change to an existing deployment introduces new risks (e.g., health-related ricks, stability-related risks, security-related risks, or the like) to the existing deployment. For example, software related changes (e.g., installation of a new software in an existing deployment) often stand out as one of the primary causes behind interruptions in deployment performance. Other forms of changes (e.g., addition of new dependencies, modifications to service contracts, adjustments to configuration values for implementing new services and/or features, or the like) also carry inherent risks and potential impacts.

As another example, deploying new software releases (e.g., using the CI/CD pipeline) to an existing deployment always comes with inherent risks. These risks may include: (i) reduced availability as a result of one or more systems (making up the existing deployment) going offline and causing service disruptions; (ii) increased latency where response times may slow down, leading to diminished user experience; (iii) incorrect functionality where bugs and errors in the new software may result in unexpected behaviors or malfunctions of the new and/or already existing software in the existing deployment; (iv) unauthorized usage where security vulnerabilities can be exploited, potentially compromising the entire system's integrity and exposing sensitive data; (v) cascading effects where a single issue within one system (of systems making up the deployment) can have a ripple effect, impacting other interconnected systems within the existing deployment; or the like.

Each of these incidents and issues poses significant challenges and potential consequences to the deployments (e.g., causes a negative impact to the functionalities of the systems (e.g., computers) making up the deployments). To mitigate and potentially eliminate (e.g., avoid) these incidents and issues, one or more embodiments disclosed herein provide a risk estimation process that may be used to estimate and/or determine a risk involved with each change to an existing deployment.

The risk estimation process of one or more embodiments may employ a method that identifies and quantifies the difference(s) between deployments (e.g., an existing deployment and a not yet deployed deployment) in a normalized and quantitative manner. The method further provides a measure of the level of risk associated with the new deployment. This level of risk may then be compared against one or more policies (e.g., deployment policies) of an entity (e.g., an entity maintaining/providing the deployments) to determine whether one or more deployments may actually be deployed.

As such, the above discussed risks related to deployment changes can be caught and identified early such that the above incidents and issues can likely be entirely avoided. Thus, an improved deployment deploying process that may also directly improve the functionalities of the systems (e.g., computing devices) making up the deployments may be obtained. In particular, by reducing and/or completely eliminating service disruptions, increased latencies, and the other incidents and issues discussed above, the functionalities (e.g., better and/or more efficient usage of limited computing resources such as processing and memory resources, security, or the like) of the systems (e.g., computing devices) making up the deployments can be directly improved.

In an embodiment, a method for managing deployments that provide computer-implemented services using one or more data processing systems is provided. The method may include: obtaining deployment data, the deployment data comprising first deployment data of a first deployment of the deployments and second deployment data of a second deployment of the deployments; using the first deployment data and the second deployment data to calculate a similarity value, the similarity value indicating a similarity between the first deployment and the second deployment; using the similarity value to determine risks associated with deploying the second deployment; generating deployment instructions based on the risks; and executing the deployment instructions to cause the one or more data processing systems to deploy the second deployment or cause the one or more data processing systems to maintain the first deployment.

The second deployment is different from the first deployment, the first deployment is a currently executing deployment on the one or more data processing systems, and the second deployment is a proposed deployment that has not yet been deployed.

The second deployment comprises one or more changes to the computer-implemented services provided by the first deployment, and deploying the second deployment comprises changing the first deployment into the second deployment by effectuating the one or more changes to the computer-implemented services provided by the first deployment.

The risks comprise a health-related risk, a stability-related risk, and a security-related risk to the first deployment should the first deployment be changed into the second deployment.

Using the first deployment data and the second deployment data to calculate the similarity value may include: generating a first deployment distance matrix using the first deployment data and a second deployment distance matrix using the second deployment data, wherein the similarity value is a distance score between the first deployment distance matrix and the second deployment distance matrix.

The distance score is a Wasserstein distance between the first deployment distance matrix and the second deployment distance matrix.

Using the similarity value to determine the risks may include: comparing the distance score to one or more predetermined risk threshold values, wherein each of the one or more predetermined risk threshold values is associated with different levels of risks for deploying the second deployment.

The first deployment data comprises first components of the first deployment and first attributes of each of the first components of the first deployment, and the second deployment data comprises second components of the second deployment and second attributes of each of the second components of the second deployment.

The first attributes are associated with changes applied to each of the first components and the second attributes are associated with changes applied to each of the second components.

The first attributes are further associated with metrics of the first components and the second attributes are further associated with the metrics of the second components.

In an embodiment, a non-transitory media is provided. The non-transitory media may include instructions that when executed by a processor cause the computer-implemented method to be performed.

In an embodiment, a data processing system (e.g., a deployment manager) is provided. The data processing system may include the non-transitory media and a processor, and may perform the computer-implemented method when the computer instructions are executed by the processor.

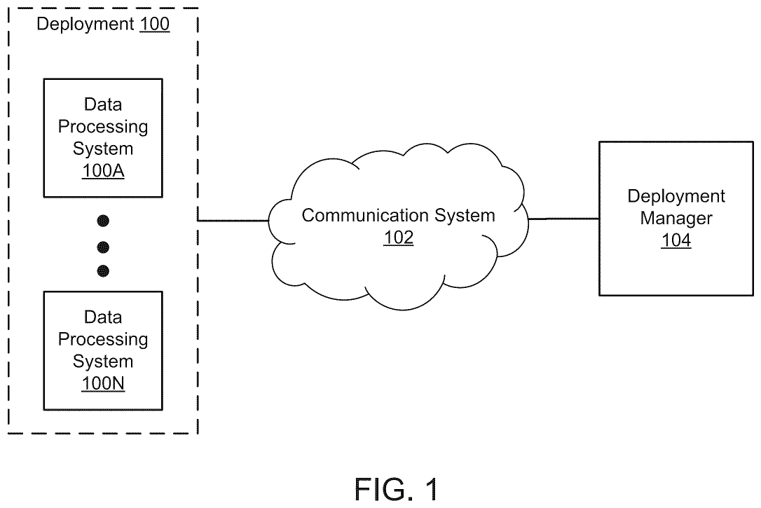

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, various data processing systems (making up a deployment) may be configured in predetermined manners to place them in operating states that are known to allow the computer implemented services to be provided. However, overtime, an entity maintaining and/or providing the deployment may wish to make changes to the deployment (e.g., add new components to be able to provide new computer-implemented services, changes existing configurations, fix current issues, or the like).

For example, assume that the deployment is a version 1.0 deployment of a software deployment that provides various computer-services. Overtime, developers of the deployment may make changes to this version 1.0 and may then wish to launch an updated version (e.g., version 1.1) of this deployment.

A risk estimation process may be employed to identify and quantify difference(s) between these two deployments (e.g., the version 1.0 deployment and the version 1.1 deployment) in a normalized and quantitative manner. Such difference(s) may be used to determine a level of risk associated with deploying the new deployment (e.g., the version 1.1 deployment). These risks may include health-related risks, stability-related risks, security-related risks, or the like, such as, but not limited to: (i) reduced availability as a result of one or more systems (making up the existing deployment) going offline and causing service disruptions; (ii) increased latency where response times may slow down, leading to diminished user experience; (iii) incorrect functionality where bugs and errors in the new software may result in unexpected behaviors or malfunctions of the new and/or already existing software in the existing deployment; (iv) unauthorized usage where security vulnerabilities can be exploited, potentially compromising the entire system's integrity and exposing sensitive data; and (v) cascading effects where a single issue within one system (of systems making up the deployment) can have a ripple effect, impacting other interconnected systems within the existing deployment.

The identified level of risk may then be compared against deployment policies of an entity to determine whether the new deployment may actually be deployed. As a result, certain risks may be eliminated and an improved deployment deploying process that may also directly improve the functionalities of the systems (e.g., computing devices) making up the deployments may be obtained.

To provide the above noted functionality, the system may include deployment 100, and deployment manager 104. Each of these components is discussed below.

Deployment 100 may provide desired computer implemented services. To provide the computer implemented services, deployment 100 may include any number of data processing systems 100A-100N. Data processing systems 100A-100N may (i) contribute to the computer implemented services, (ii) provide information regarding its configuration to deployment manager 104, and (iii) update its configuration based on information provided by deployment manager 104.

Deployment manager 104 may provide management services for deployment 100. The management services may be performed by (i) monitoring changes (e.g., proposed changes) to deployment 100, (ii) identifying whether the proposed changes are acceptable and/or may be improved, and (iii) when the proposed changes are unacceptable and/or may be improved, deployment manager 104 may provide information to an owner (e.g., user) of the deployment manager 104.

In an embodiment, users of deployment 100 contract with operators of deployment manager 104 for desired computer implemented services. For example, it may be the responsibility of an operator of deployment manager 104 to maintain deployment 100 in a manner that allows for the computer implemented services to be provided. A subscription model (e.g., one example of deployment policies) for such services may be utilized, which may define responsibilities, cost, and/or other aspects of the relationship between users of computer implemented services provided by deployment 100 and operators of deployment manager 104 and/or deployment 100.

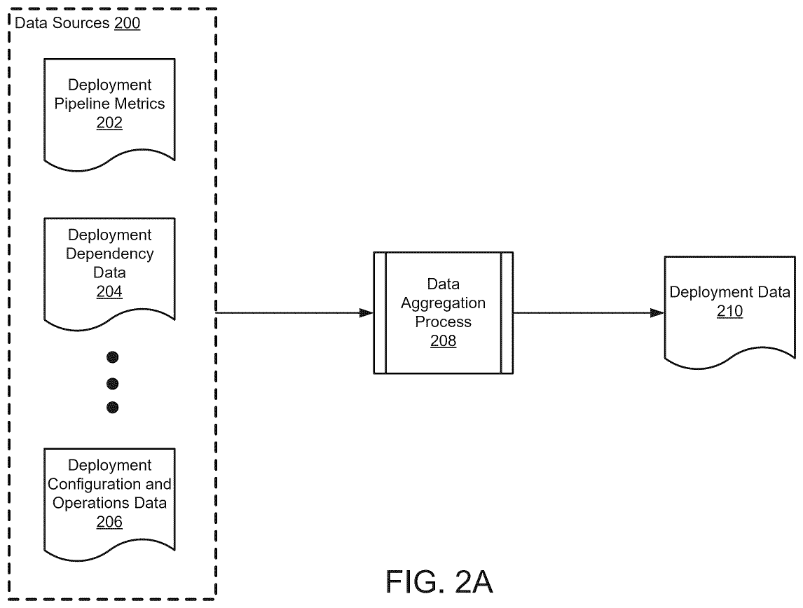

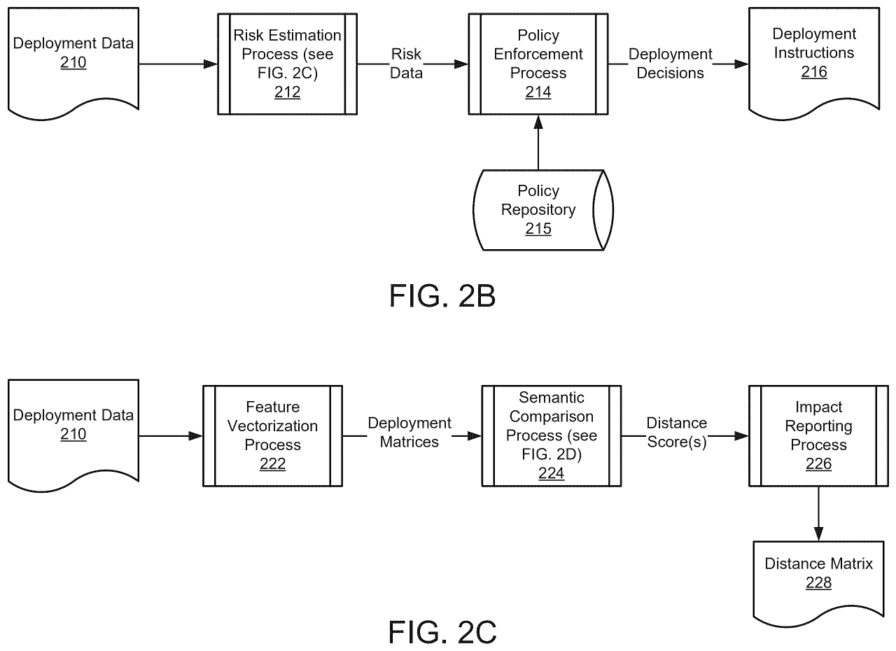

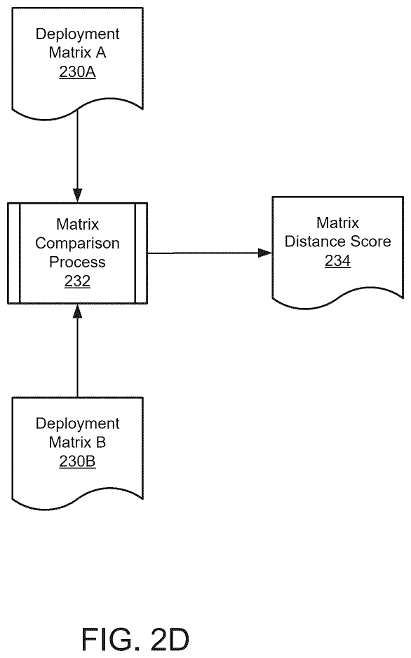

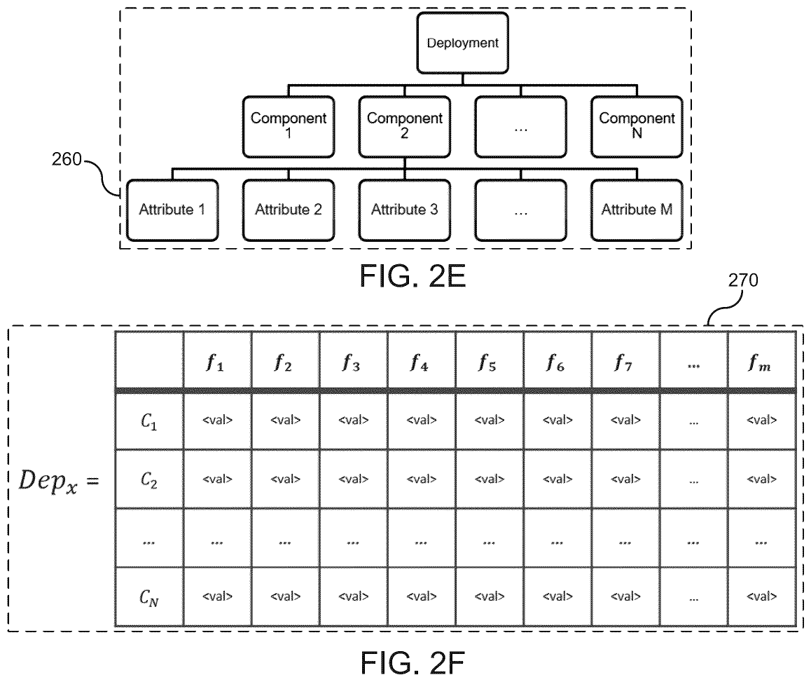

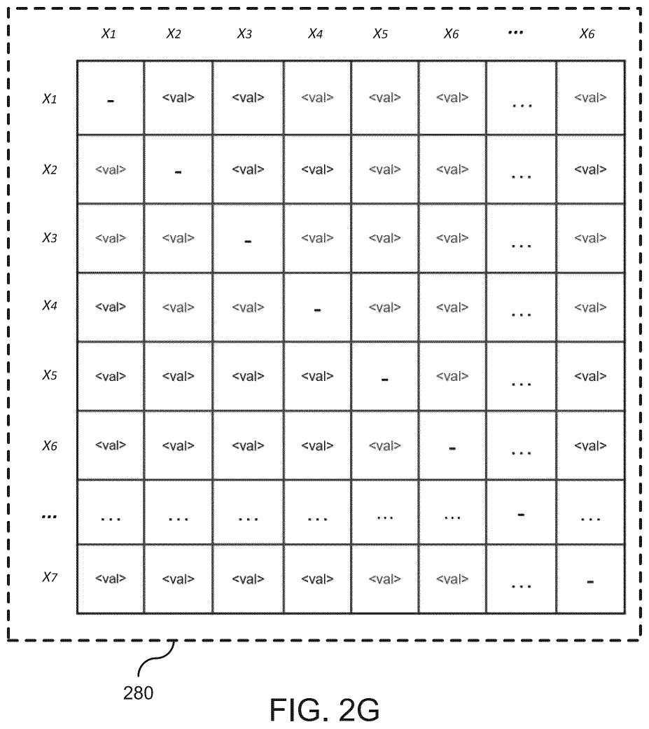

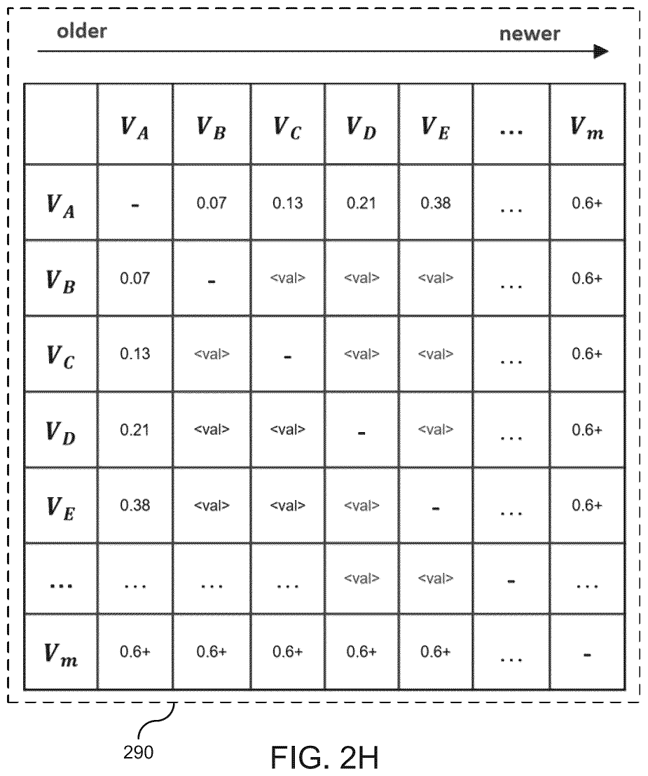

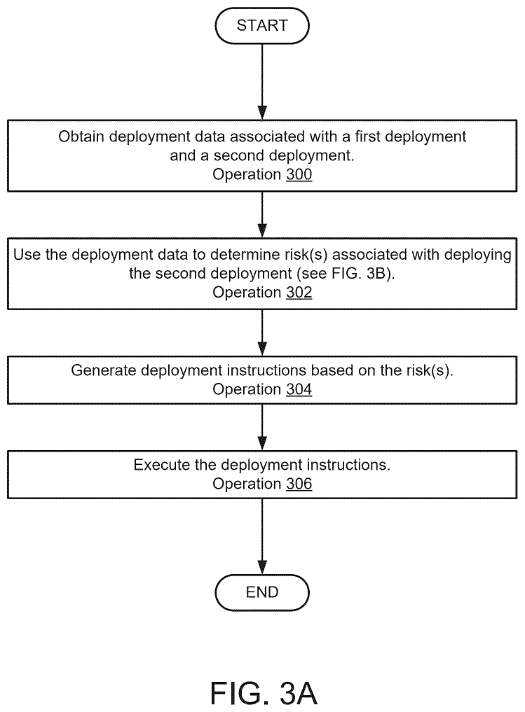

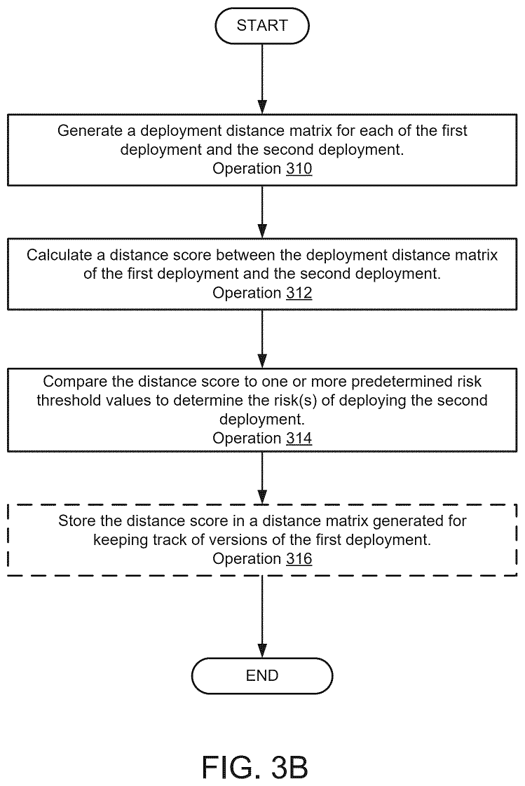

While providing their functionality, any of deployment 100 and deployment manager 104 may perform all, or a portion, of the flows and methods shown in FIGS. 2A-3B.

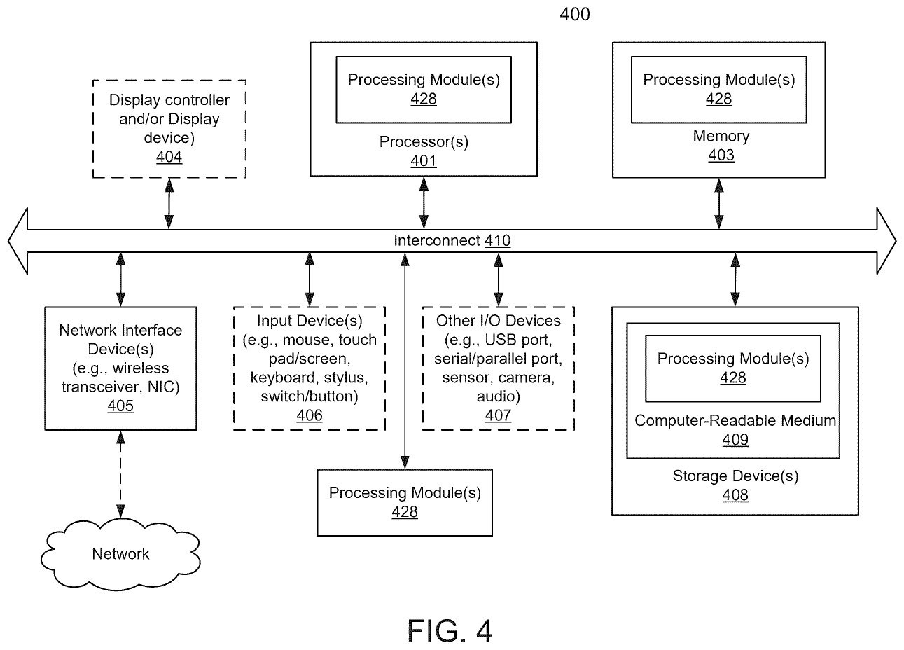

Any of (and/or components thereof) deployment 100 and deployment manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 202, 204, 206 etc.) is used to represent data structures, a second set of shapes (e.g., 208, 212, 214, etc.) is used to represent processes performed using and/or that generate data, and a third set of shapes (e.g., 215, etc.) is used to represent large scale data structures such as databases.

Turning to FIG. 2A, a first data flow diagram in accordance with one or more embodiments is shown. The first data flow diagram may illustrate data used for the risk estimation process of embodiments disclosed herein.

As shown in FIG. 2A, a data aggregation process 208 is implemented to retrieve (e.g., aggregate) data from various data sources 200 in order to generate deployment data 210. For example, the data aggregation process 208 may be implemented by deployment manager 104 (see FIG. 1) to retrieve deployment-related data from the data processing systems 100A-100N making up deployment 100.

In embodiments, data sources 200 may include deployment pipeline metrics 202 (e.g., CI/CD pipeline metrics), deployment dependency data 204 (e.g., a deployment dependency tree showing all upstream and downstream components and/or services provided by the deployment), and deployment configuration and operations data (e.g., GitOps and/or artifacts data of the deployment 100). Each of these data sources 200 may provide parameters, configurations, metrics, attributes and other data related to the development lifecycle from various tools (e.g., GitOps, CI/CD related tools, dependency trees, or the like) that contribute towards the release of deployment 100. Such data sources 200 may provide data such as, but not limited to: bug fixes, new features, security hotfixes, and much more of the deployment 100.

Other types of data and other data sources (not shown in FIG. 2A) that are able to provide similar development lifecycle data may also be utilized without departing from the scope of embodiments disclosed herein.

Once aggregated (e.g., by data aggregation process 208), the deployment data 210 may include information/data on the components of deployment 100 and attributes of each of the components. Each component may be related to one or more functional services of the deployment that include self-contained features/tasks. Each component may also have additional sub-components. Changes associated with each component (or sub-component) may be captured in the form of attribute categories. An example deployment data 210 is shown in FIG. 2E.

Turning to FIG. 2E, FIG. 2E shows an example hierarchy tree 260 included in a deployment data (e.g., 210 of FIG. 2A) of deployment 100. Although sub-components are not shown, this hierarchy tree 260 may also include various sub-components, each with their own set of attributes. As shown in FIG. 2E, deployment 100 may include various components (e.g., component 1 through N). Each of these components may then have a set of attributes (e.g., attributes 1 through M).

Each of the attributes may relay information about each component. Such information may include, but is not limited to: dependency information, business semantics information, behavioral statistics information. Business semantics may be attributes gathered by business metrics and may include, for example: total number of bug fixes, severity of bug fixes, total number of new features, criticality of features, security hot-fix, total lines-of-code, dependency components predecessor, dependency components successor, platforms affected, reboot requirement, or the like. Behavioral statistics may include, for example: total number of code lines changed, total number of commits, ratio of change line vs total code lines, number of programmers involved, time range of commits, total number of software libraries involved, deployment target system scale, deployment system version change, number of bugs in log in staging env, or the like. Dependency information may indicate each upstream and or downstream dependency of a component (e.g., service).

Other types of data related to the deployment lifecycle not discussed above may also be included without departing from embodiments disclosed herein.

Turning back now to FIG. 2B, FIG. 2B shows a second data flow diagram in accordance with one or more embodiments is shown. The second data flow diagram may illustrate a deployment deploying process of embodiments disclosed herein.

As shown in FIG. 2B, deployment data 210 may be obtained for at least two deployments. The first deployment of the two deployments may be an existing deployment that is already deployed and is providing computer-implemented services. The second deployment of the two deployments may be a proposed deployment that has not yet been deployed. The second deployment may also include one or more changes to the first deployment. For example, the second deployment may be a new version of the first deployment.

Alternatively, the deployment data 210 may be associated with two previously retired deployments. For example, assume that the current deployed deployment is at version 1.3, the deployment data 210 may be associated with versions 1.0 and 1.1 of the deployed deployment. Any number of deployment data 210 for any number of deployments (deployed, retired, or proposed) may be obtained without departing from the scope of embodiments disclosed herein.

For ease of explanation, the below examples of FIGS. 2B and 2C will be discussed with respect to just two deployments (namely, a currently deployed deployment and a proposed deployment that is an update of the deployed deployment).

The deployment data 210 may be ingested into a risk estimation process 212. The risk estimation process 212 may be configured to identify and quantify difference(s) between these two deployments in a normalized and quantitative manner. Such difference(s) may be used to determine a level of risk associated with deploying the new deployment (e.g., the proposed deployment that is an update of the deployed deployment).

Turning first to FIG. 2C, FIG. 2C shows a third data flow diagram in accordance with one or more embodiments directed to the risk estimation process. Initially, the deployment data 210 (of the two deployments) is ingested into a feature vectorization process 222 where the deployment data 210 is transformed into matrices (e.g., distance matrices). Other types of matrices (besides distance matrices) may also be used without departing from the scope of embodiments disclosed herein.

To transform the deployment data 210 into distance matrices, the deployment data is first converted into an n×m matrix 270 as shown in FIG. 2F. The n×m matrix 270 is an example matrix generated using the hierarchy tree 260 shown in FIG. 2E. In particular, as shown in FIG. 2F, each the set of attributes for every component is represented as an m-dimensional vector. Each attribute can be depicted as a feature (e.g., features fl through fm). Components of the deployment are then stacked to achieve the n×m matrix 270.

In embodiments, feature data may require transformation before further processing to result in the values (e.g., “<val>”) shown in the n×m matrix 270. For example, categorical (e.g., nominal, ordinal, or the like) criteria may be converted into numeric features using, for example, label encoders, one-hot vector encoders, or the like. Data for each criterion may also be normalized using techniques such as: unity base, linear, vector, or the like. Other techniques (and/or encoders) not listed here may also be used without departing from the scope of embodiments disclosed herein.

Once the n×m matrix 270 is obtained for each deployment (e.g., a currently deployed deployment and a proposed deployment that is an update of the deployed deployment), the matrices are ingested into a semantic comparison process 224 as shown in FIG. 2C.

In particular, as part of the semantic comparison process 224, each matrix can be thought of as a distribution in an n-dimensional space (e.g., two empirical distributions of X={x₁, x₂, . . . x₂} and Y={y₁, y₂, . . . yₘ} where xᵢ and yⱼ are discrete points representing attributes of two deployments. These two empirical distributions may be defined as:

$$μ = {\sum }_{i}^{n} {p}_{i} {δ}_{{x}_{i}} and v = {\sum }_{j}^{m} {q}_{j} {δ}_{{y}_{j}} \qquad ( Equation 1 )$$

where p and q are vectors of probability weights associated with each point-set. This representation provides “importance” to some attributes over others depending on the probability of occurrence in the joint probability distribution space, and will result in the construction of a distance matrix for each of the deployments. An example of a distance matrix 280 constructed for a deployment is shown in FIG. 2G.

As shown in FIG. 2G, the distance matrix 280 includes each attribute (namely, attributes X₁ through Xₙ) that was included in the n×m matrix 270 shown in FIG. 2F. The distance matrix 280 also shows the importance (e.g., as the values “<val>”) to some attributes over others depending on the probability of occurrence in the joint probability distribution space. For example, since X₁ is the same as X₁, there would be no value to show how the difference between this attribute. However, a value (“<val>”) is shown to show the difference (e.g., importance) between attributes X₁ and X₂.

Once distance matrices (e.g., distance matrix 280) have been generated for each deployment, the semantic comparison process 224 employs a matrix comparison process 232 (as shown in FIG. 2D) to generate a matrix distance score 234. In particular, as shown in FIG. 2D, a deployment matrix A 230A (e.g., the distance matrix for the first deployment) and a deployment matrix B 230B (e.g., the distance matrix for the second deployment) are fed into the matrix comparison process 232 to obtain a matrix distance score 234.

The matrix comparison process 232 may be configured to calculate a Wasserstein distance (as the matrix distance score) between deployment matrix A 230A and deployment matrix B 230B. The Wasserstein distance may be calculated using the Wasserstein distance-based Optimal transport technique. In embodiments, a smaller Wasserstein distance indicates a greater similarity between the distributions, while a larger distance implies more dissimilarity. The cost associated with transporting unit mass for the two empirical distributions defined in terms of Wasserstein distance may be shown as:

$$ℒ ( {C}_{a} , {C}_{b} ) = Wd ( {C}_{a} , {C}_{b} ) = {\sum }_{ij}^{n} {Γ}_{ij} d ( {x}_{i} , {y}_{j} ) \qquad ( Equation 2 )$$

where Γᵢⱼ is the “mass” moved from x to y.

Once the matrix distance score 234 is obtained, the matrix distance score 234 may be provided to an impact reporting process 226 shown in FIG. 2C. In particular, as part of the impact reporting process 226, the matrix distance score 234 may be run through a normalization step where the distance metrics are normalized to real values between 0 and 1 instead of an arbitrary real value. This allows the comparison between the two deployments (e.g., the currently deployed deployment and the proposed deployment that is an update of the deployed deployment) to be more easily understood.

Once the matrix distance score 234 is normalized, a hyperparameter threshold value (e.g., a value based on various requirements of the entity managing the deployment including information from the subscription model maintained by the deployment manager 104) may be used to determine the risks and/or criticalities involved with deploying the second deployment (e.g., the proposed deployment that is an update of the currently deployed deployment).

The hyperparameter threshold may be illustrated as one or more predetermined risk threshold values where each of the one or more predetermined risk threshold values is associated with different levels of risks for deploying the second deployment. As a non-limiting example, any value between the range 0 to 0.3 may be considered low risk, any value between the range of 0.31-0.7 may be considered medium risk, while any value from 0.71-1.0 may be considered high risk. In embodiments, multi-mode classification may be utilized to categorize each level of risk into color-coded bands (e.g., low risk-optional check (green); medium risk-recommend check (orange); and high-risk-mandatory check (red)).

Other methods and/or techniques for quantifying the different level of risks may also be used without departing from the scope of embodiments disclosed herein.

In embodiments, during the impact reporting process 226 of FIG. 2C, the matrix distance scores between various deployments (e.g., various versions of the same deployment) may optionally be stored into another distance matrix 228. An example of this distance matrix 228 is shown in FIG. 2H.

As shown in FIG. 2H, an overall deployment distance matrix 290 is shown where the matrix distance scores of different versions of the same deployment are stored. In particular, the versions (e.g., versions V_{A} through Vₘ where version A is the oldest version and version m is the newest version) of the deployment is populated and compared against one another (using the matrix distance score (e.g., the values (“<val>”) shown in the overall deployment distance matrix 290) calculated between each version). As the versions move further and further away, it can be observed that the difference between the deployments also increase (e.g., higher matrix distance score).

Returning now to FIG. 2B, the risk estimation process 212 may provide the matrix distance score 234 of the two deployments (e.g., the currently deployed deployment and the proposed deployment that is an update of the deployed deployment) (as well as the distance matrix 228) as risk data to policy enforcement process 214.

The policy enforcement process 214 may be configured to compare the risk data to one or more deployment policies (e.g., deployment policies stored in policy repository, subscription information, or the like) to determine whether the proposed deployment should be deployed to replace the currently deployed deployment. Namely, whether the changes (e.g., new software additions, configuration changes, or the like) should be applied to the currently deployed deployment).

Based on the comparison, the policy enforcement process 214 may generate deployment decisions that are included in deployment instructions 216. The deployment instructions 216 may specify what should be done with the proposed deployment. For example, the deployment instructions (once executed by deployment manager 104 and/or by data processing systems 100A-100N of deployment 100) may cause: (i) no deployment of the proposed deployment; (ii) full deployment of the proposed deployment; (iii) partial deployment of the proposed deployment; (iv) piece-wise deployment of the proposed deployment; (v) delayed deployment of the proposed deployment at a predetermined time (e.g., a time of lower traffic and/or usage of deployment 100); request of human intervention to resolve any unresolved issues or flags included during policy enforcement process 214; or the like. Other actions not discussed above regarding the proposed deployment and/or the currently deployed deployment may be taken without departing from the scope of embodiments disclosed herein.

As a result, embodiments disclosed herein provide methods and systems that are advantageously able to predict and identify potential risks associated with deployment changes before new changes to existing deployments are deployed.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3B illustrate flow charts of methods that may be performed by the components of the system of FIG. 1 in accordance with an embodiment. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of managing deployments that provide computer-implemented services using one or more data processing systems in accordance with one or more embodiments is shown. The method may be performed, for example, by any of the components of the system of FIG. 1, and/or other components not shown therein.

At operation 300, as discussed above in reference to FIGS. 2A-2D, deployment data associated with a first deployment and a second deployment may be obtained.

In embodiments, the second deployment may be different from the first deployment, the first deployment may be a currently executing deployment on the one or more data processing systems (e.g., 100A-100N of FIG. 1), and the second deployment may be a proposed deployment that has not yet been deployed.

Additionally, the second deployment may include one or more changes to the computer-implemented services provided by the first deployment, and deploying the second deployment may include changing the first deployment into the second deployment by effectuating the one or more changes to the computer-implemented services provided by the first deployment.

At operation 302, as discussed above in reference to FIGS. 2A-2D, the deployment data (of the first and second deployments) may be used to determine risk(s) associated with deploying the second deployment.

In embodiments, the risks may include any of combination of a health-related risk, a stability-related risk, and a security-related risk to the first deployment should the first deployment be changed into the second deployment. Additional details of determining the risks are discussed in the flow diagram of FIG. 3B, which include methods that may be performed, for example, by any of the components of the system of FIG. 1, and/or other components not shown therein.

In particular, at operation 310 of FIG. 3B, as discussed above in reference to FIGS. 2C and 2E-2G, a deployment distance matrix may be generated for each of the first deployment and the second deployment using the deployment data of each of the first deployment and the second deployment.

At operation 312, as discussed above in reference to FIGS. 2C-2D and 2G, a distance score (e.g., a matrix distance score) may be calculated between the deployment distance matrices of the first deployment and the second deployment.

At operation 314, as discussed above in reference to FIGS. 2C and 2G-2H, the distance score may be compared to one or more predetermined risk threshold values to determine whether there could be any risks in the deploying of the second deployment.

At operation 316, as discussed above in reference to FIGS. 2C and 2H, the distance score between the first deployment and the second deployment may (optionally) be stored in another distance matrix (e.g., overall deployment distance matrix 290 of FIG. 2H) for keeping tracks of the changes between various versions of the first deployment.

The method of FIG. 3B may end following operations 314 or 316.

Turning back to FIG. 3A, at operation 304, as discussed above in reference to FIGS. 2A-2C, deployment instructions may be generated based on the risk(s) (namely, the matrix distance score between the first deployment and the second deployment). The deployment instructions may be generated (automatically by the deployment manager without user intervention or manually by one or more users of the deployment manager) based on comparing the matrix distance score to one or more deployment policies (including subscription information maintained by the deployment manager).

At operation 306, as discussed above in reference to FIGS. 2A-2C, the deployment instructions are executed (e.g., by the deployment manager) to effectuate the deployment instructions on the first deployment (e.g., the currently deployed deployment).

For example, in embodiments, the deployment instructions may be executed to cause the one or more data processing systems to deploy the second deployment or cause the one or more data processing systems to maintain the first deployment (without deploying the second deployment).

The method of FIG. 3A may end following operation 306.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing deployments that provide computer-implemented services using one or more data processing systems, the method comprising:
obtaining deployment data, the deployment data comprising first deployment data of a first deployment of the deployments and second deployment data of a second deployment of the deployments;
using the first deployment data and the second deployment data to calculate a similarity value, the similarity value indicating a similarity between the first deployment and the second deployment;
using the similarity value to determine risks associated with deploying the second deployment;
generating deployment instructions based on the risks; and
executing the deployment instructions to cause the one or more data processing systems to deploy the second deployment or cause the one or more data processing systems to maintain the first deployment.

2. The method of claim 1, wherein the second deployment is different from the first deployment, the first deployment is a currently executing deployment on the one or more data processing systems, and the second deployment is a proposed deployment that has not yet been deployed.

3. The method of claim 2, wherein the second deployment comprises one or more changes to the computer-implemented services provided by the first deployment, and deploying the second deployment comprises changing the first deployment into the second deployment by effectuating the one or more changes to the computer-implemented services provided by the first deployment.

4. The method of claim 3, wherein the risks comprise a health-related risk, a stability-related risk, and a security-related risk to the first deployment should the first deployment be changed into the second deployment.

5. The method of claim 1, wherein using the first deployment data and the second deployment data to calculate the similarity value comprises:
generating a first deployment distance matrix using the first deployment data and a second deployment distance matrix using the second deployment data,
wherein the similarity value is a distance score between the first deployment distance matrix and the second deployment distance matrix.

6. The method of claim 5, wherein the distance score is a Wasserstein distance between the first deployment distance matrix and the second deployment distance matrix.

7. The method of claim 6, wherein using the similarity value to determine the risks comprises:
comparing the distance score to one or more predetermined risk threshold values, wherein each of the one or more predetermined risk threshold values is associated with different levels of risks for deploying the second deployment.

8. The method of claim 5, wherein the first deployment data comprises first components of the first deployment and first attributes of each of the first components of the first deployment, and the second deployment data comprises second components of the second deployment and second attributes of each of the second components of the second deployment.

9. The method of claim 8, wherein the first attributes are associated with changes applied to each of the first components and the second attributes are associated with changes applied to each of the second components.

10. The method of claim 9, wherein the first attributes are further associated with metrics of the first components and the second attributes are further associated with the metrics of the second components.

11. A non-transitory machine-readable medium having instructions stored therein, which when executed by a processor, cause the processor to perform operations for managing deployments that provide computer-implemented services using one or more data processing systems, the operations comprising:
obtaining deployment data, the deployment data comprising first deployment data of a first deployment of the deployments and second deployment data of a second deployment of the deployments;
using the first deployment data and the second deployment data to calculate a similarity value, the similarity value indicating a similarity between the first deployment and the second deployment;
using the similarity value to determine risks associated with deploying the second deployment;
generating deployment instructions based on the risks; and
executing the deployment instructions to cause the one or more data processing systems to deploy the second deployment or cause the one or more data processing systems to maintain the first deployment.

12. The non-transitory machine-readable medium of claim 11, wherein the second deployment is different from the first deployment, the first deployment is a currently executing deployment on the one or more data processing systems, and the second deployment is a proposed deployment that has not yet been deployed.

13. The non-transitory machine-readable medium of claim 12, wherein the second deployment comprises one or more changes to the computer-implemented services provided by the first deployment, and deploying the second deployment comprises changing the first deployment into the second deployment by effectuating the one or more changes to the computer-implemented services provided by the first deployment.

14. The non-transitory machine-readable medium of claim 13, wherein the risks comprise a health-related risk, a stability-related risk, and a security-related risk to the first deployment should the first deployment be changed into the second deployment.

15. The non-transitory machine-readable medium of claim 11, wherein using the first deployment data and the second deployment data to calculate the similarity value comprises:
generating a first deployment distance matrix using the first deployment data and a second deployment distance matrix using the second deployment data,
wherein the similarity value is a distance score between the first deployment distance matrix and the second deployment distance matrix.

16. A deployment manager, comprising:
a processor; and
a memory coupled to the processor to store instructions, which when executed by the processor, cause the deployment manager to perform operations for managing deployments that provide computer-implemented services using one or more data processing systems, the operations comprising:
obtaining deployment data, the deployment data comprising first deployment data of a first deployment of the deployments and second deployment data of a second deployment of the deployments;
using the first deployment data and the second deployment data to calculate a similarity value, the similarity value indicating a similarity between the first deployment and the second deployment;
using the similarity value to determine risks associated with deploying the second deployment;
generating deployment instructions based on the risks; and
executing the deployment instructions to cause the one or more data processing systems to deploy the second deployment or cause the one or more data processing systems to maintain the first deployment.

17. The deployment manager of claim 16, wherein the second deployment is different from the first deployment, the first deployment is a currently executing deployment on the one or more data processing systems, and the second deployment is a proposed deployment that has not yet been deployed.

18. The deployment manager of claim 17, wherein the second deployment comprises one or more changes to the computer-implemented services provided by the first deployment, and deploying the second deployment comprises changing the first deployment into the second deployment by effectuating the one or more changes to the computer-implemented services provided by the first deployment.

19. The deployment manager of claim 18, wherein the risks comprise a health-related risk, a stability-related risk, and a security-related risk to the first deployment should the first deployment be changed into the second deployment.

20. The deployment manager of claim 16, wherein using the first deployment data and the second deployment data to calculate the similarity value comprises:
generating a first deployment distance matrix using the first deployment data and a second deployment distance matrix using the second deployment data,
wherein the similarity value is a distance score between the first deployment distance matrix and the second deployment distance matrix.
